(19) United States
(12) Patent Application Publication
(10) Pub. No.: US 2015/0194737 A1
(43) Pub. Date: Jul. 9, 2015

(54) WIRELESS DEVICE

(71) Applicant: ZTE CORPORATION, Shenzhen (CN)

(72) Inventors: Yang Liu, Shenzhen (CN); Jinping Ma, Shenzhen (CN)

(73) Assignee: ZTE CORPORATION, Shenzhen, GD (CN)

(21) Appl. No.: 14/411,516

(22) PCT Filed: Jun. 21, 2013
(86) PCT No.: PCT/CN2013/077688

§ 371 Date: Dec. 28, 2014

(30) Foreign Application Priority Data
Jun. 25, 2012 (CN) 201220299091.X

(51) Int. Cl. H01Q 21/00; H01Q 1/24; H01Q 1/48

(52) U.S. Cl. CPC H01Q 21/0006; H01Q 1/48; H01Q 1/243

(57) ABSTRACT

A wireless device comprises a mainboard (8) and a plurality of antennae. The surface of the mainboard (8) is provided with the plurality of antennae. The interior of the mainboard (8) comprises a mainboard reference ground (9). Each of the plurality of antennae is electrically connected to the mainboard reference ground (9) respectively. This solution improves the isolation degree between common-frequency antennae effectively, thereby avoiding the mutual interference of short-range common-frequency antennae.

### TECHNICAL FIELD

The disclosure relates to the communication field, in particular to a wireless device.

### BACKGROUND

The appearance of technologies, such as a third generation (3rd Generation, 3G for short) and long term evolution (Long Term Evolution, LTE for short) promotes the development of wireless broadband access technology and industry, and as the requirements of services become more and more wide, functions required by wireless products to provide also become more and more. With regard to a mobile terminal (for example, a mobile phone) and other wireless access products, etc., it requires to perform a data service while providing a voice service, and since the voice service and a data transmission service are among different function modules, but work on the same frequency band, which then inevitably brings the mutual interference problem among two or more antennae for realizing voice and data services.

In order to solve the technical problem, antennae which realize the above-mentioned two or more functions are set far away enough in the traditional art, and the isolation degree between antennae is big enough, and such layout may reach a certain effect. However, at the present, the requirements on the appearance of products become more and more high, and miniaturization of the products has become an inevitable trend for the future. This defines that the distance between antennae cannot be placed ideally, and the isolation degree between antennae also cannot satisfy requirements.

With regard to the problem of small isolation degree between function antennae in the relevant art, an effective solution has not been proposed yet.

### SUMMARY

With regard to the problem of small isolation degree between function antennae in the relevant art, the present disclosure provides a wireless device for at least solving the above-mentioned problems.

According to one aspect of the present invention, a wireless device is provided, comprising: a mainboard and a plurality of antennae, wherein a surface of the mainboard is provided with the plurality of antennae, and an interior of the mainboard comprises a mainboard reference ground, and each of the plurality of antennae is electrically connected to the mainboard reference ground respectively.

Preferably, the each of the plurality of antennae comprises at least one antenna ground feed point; and the wireless device further comprises: a plurality of metal grounds respectively connected to the at least one antenna ground feed point, wherein the each of the plurality of metal grounds is electrically connected to the mainboard reference ground.

Preferably, the number of the at least one antenna ground feed point comprised by the each of the plurality of antennae is greater than or equal to 2.

Preferably, the at least one antenna ground feed point is provided in a middle part or end part of the each of the plurality of antennae.

Preferably, the each of the plurality of metal grounds comprises at least one through hole, and the each of the plurality of metal grounds is electrically connected to the mainboard reference ground via the at least one through hole.

Preferably, the number of the at least one through hole comprised by the each metal ground is determined according to an area of the each of the plurality of metal ground.

Preferably, the plurality of antennae are provided on edges of different sides of the mainboard.

Preferably, the plurality of antennae comprise at least two of the following: an LTE primary antenna, an LTE secondary antenna, a 3G antenna and a WiFi antenna.

Preferably, the each antenna of the plurality of antennae comprises at least one antenna feed point.

In the present disclosure, the device comprises a mainboard and a plurality of antennae, wherein the interior of the mainboard comprises a mainboard reference ground, and each of the plurality of antennae is electrically connected to the mainboard reference ground respectively. The above solution effectively improves the isolation degree between common-frequency antennae, thus solving the mutual interference of short-range common-frequency antennae in relevant art.

### BRIEF DESCRIPTION OF THE DRAWINGS

Drawings, provided for further understanding of the present disclosure and forming a part of the specification, are used to explain the present disclosure together with embodiments of the present disclosure rather than to limit the present disclosure. In the accompanying drawings:

FIG. 1 is a top-schematic view of a preferred common-frequency multi-antenna layout according to an embodiment of the present disclosure;

and FIG. 2 is a side-schematic view of a preferred common-frequency multi-antenna layout according to an embodiment of the present disclosure.

### DESCRIPTION OF EMBODIMENTS

The present disclosure is described below with reference to the accompanying drawings and embodiments in detail. It should be noted that the embodiments and the characteristics of the embodiments can be combined with each other if no conflict is caused.

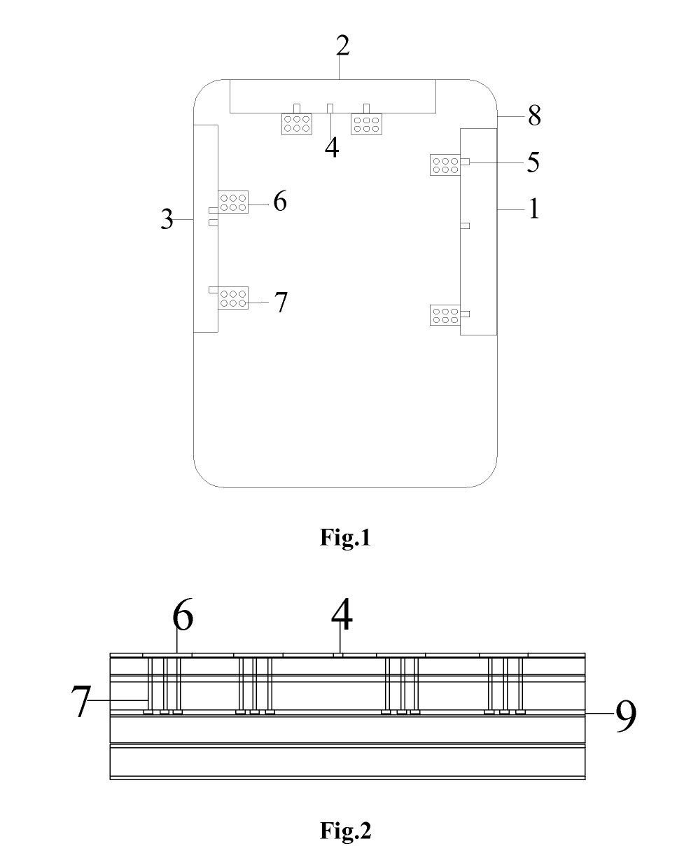

The present embodiment provides a wireless device, and FIG. 1 is a top-schematic view of a preferred common-frequency multi-antenna layout according to an embodiment of the present disclosure, and FIG. 2 is a side-schematic view of a preferred common-frequency multi-antenna layout according to an embodiment of the present disclosure, and as shown in FIGS. 1 and 2, the wireless device comprises: a mainboard 8 and a plurality of antennae, wherein the surface of the mainboard 8 is provided with the plurality of antennae, and the interior of the mainboard 8 comprises a mainboard reference ground 9, and each of the plurality of antennae is electrically connected to the mainboard reference ground 9 respectively.

In the present embodiment, the plurality of common-frequency antennae on the mainboard 8 of the wireless device are connected to a mainboard reference ground 9. Since these common-frequency antennae are not connected to the same metal ground, these antennae are not of the same ground. Therefore a surface wave of an antenna cannot be directly transmitted to a feed point of another antenna, thus greatly decreasing the coupling of the surface wave, effectively improving the isolation degree between common-frequency antennae, and solving the mutual interference of short-range common-frequency antennae in the relevant art.

There are various means for connecting the plurality of common-frequency antennae on the mainboard 8 to the mainboard reference ground 9. In a preferred embodiment, each of the plurality of antennae may be provided with at least one antenna ground feed point 5, and the wireless device may further comprise a plurality of metal grounds 6, and the plurality of metal grounds 6 are connected to the at least one antenna ground feed point 5 respectively, and each of the plurality of metal grounds 6 is electrically connected to the mainboard reference ground 9. By using the manner, positions of the at least one antenna ground feed point 5 and the plurality of metal grounds 6 may be set flexibly according to specific situations in practical use, thus further improving the isolation degree between antennae.

For example, each of the plurality of antennae may comprise at least two antenna ground feed points 5. The positions of the at least two antenna ground feed points may be further optimized according to a simulation result, and the positions may be in the middle part, or may be in any position between the middle part and an end part. For example, the at least two antenna ground feed point 5 may be respectively provided in the middle part and/or end part of the each of the plurality of antennae. This manner has been proven by practise to be able to further produce a positive effect in the aspect of improving isolation degree between antennae.

In a preferred embodiment, at least one through hole 7 may be provided on each of the plurality of metal grounds 6, and the each of the plurality of metal grounds 6 may be electrically connected to the mainboard reference ground 9 via the at least one through hole 7. The interior of the mainboard 8 usually comprises a plurality of layers. The above solution that the each of the plurality of metal grounds 6 is electrically connected to the mainboard reference ground 9 through the at least one through hole 7 may avoid the metal ground connecting to other conductive layers inside of the mainboard 8, thus improving the stability of the solution.

Preferably, the number of at least one through hole 7 contained on each metal ground 6 may be determined according to the area of the metal ground 6. Generally, the more of the number of the at least one through hole 7 contained on the metal ground 6, the better. However, since the area of the metal ground 6 requires to be reasonably planned according to the layout of the mainboard 8, the number of the at least one through hole 7 may be provided as much as possible according to the area of the metal ground 6.

Preferably, the shape of the metal ground 6 may be a tetragonum, for example, a rectangle or square. The metal ground 6 with the shape of the tetragonum is set more conveniently in the layout process of the mainboard 8. Certainly, other shapes also may be employed, for example, a circle or an ellipse, etc.

Preferably, besides using the above-mentioned manner of ground isolation to improve the isolation degree among the plurality of common-frequency antennae, the manner of increasing the space distance among the above-mentioned plurality of common-frequency antennae also may be used at the same time to further improve the isolation degree. For example, the plurality of antennae may be respectively provided on edges of different sides of the mainboard 8.

Preferably, types of the plurality of antennae may be various, for example, a long term evolution (LTE) primary antenna 1, an LTE secondary antenna 2 as well as a third generation (3G) antenna 3, etc..Certainly, it is not limited to the above antennae, for example, the plurality of antennae may comprise a bluetooth antenna, a global positioning system (Global Positioning System, GPS for short) antenna, a wireless fidelity technology (Wireless Fidelity, WiFi for short, also referred to as standard 802.11b) antenna, and other function antennae in the case that these antennae are of the common-frequency which causes the isolation degree to be small, so as to improve the isolation degree among them.

Preferably, each of the plurality of antennae may comprise at least one antenna feed point 4. At present, an LTE wireless product usually requires only one antenna feed point 4, but it is not limited to one antenna feed point, for example, wireless products of other types may also require a plurality of antenna feed points 4.

The description is described in combination with preferred embodiments below, and the following preferred embodiments are in combination with the above-mentioned embodiments and preferred embodiments thereof.

A common-frequency multi-antenna layout solution is provided in a preferred embodiment of the disclosure, and the solution may be used in products, such as a mobile terminal (for example, a mobile phone, a data card, etc.) or a wireless access product. The solution may effectively solve interference problem among antennae when voice or data service are transmitted at the same time and at the same frequency, and is especially applied to LTE products at the present.

The multi-antenna layout manner in the present preferred embodiment effectively improves the isolation degree between antennae, solves the interference among antennae caused by the concurrent of voice and data services of the product at present, such as an LTE product, and at the same time satisfies miniaturization layout requirement of terminal products, such as a mobile phone.

The low isolation degree among the plurality of antennae on the mobile phone is mainly caused by electromagnetic coupling. The coupling is mainly divided into space coupling and surface wave coupling. The surface wave is a wave that propagates along the interface of the mainboard and motivated by the antenna. The surface wave sends secondary radiation when meeting a board side, component or shielding cover during propagating along the board. For example, deterioration, such as directionality of a mobile phone being severe and ripple of a directional diagram being large, is mainly because of this reason. The surface wave reaches a feed point of another antenna, and surface wave coupling occurs. There are two main methods for weakening the coupling: firstly, increasing the space distance between two antennae. The method may decrease space coupling while decreasing surface wave coupling, but the method may cause that the size of an antenna cannot be made smaller. Secondly, two antennae are not of the same ground. The method may make the surface wave not directly reach a feed point of another antenna, and in this way, the surface wave coupling may be greatly reduced.

The solution of the preferred embodiment mainly changes “ground” of two antennae working on the common frequency, thereby decreasing interference of ground current through a ground isolation manner and increasing the isolation degree among antennae. Using the solution to the layout of antennae may effectively improve the isolation degree among antennae.

Preferably, the position of the antenna may be positioned in any direction on the mainboard (for example, a PCB board) of a terminal, and may be adjusted according to the requirements of layout.

Preferably, the area and shape of the metal ground may be adjusted according to the requirement of design layout.

Preferably, the number of the plurality of antennae in the present solution may be two or more than two.

Preferably, one, two or more than two ground feed points of an antenna in the present solution may be reserved.

Preferably, positions of the antenna feed point and ground metal ground in the present solution may be adjusted according to requirements of antenna performances.

Using the above-mentioned antenna layout solution may effectively improve the isolation degree among antennae and solve interference among antennae caused by products, such as an LTE product, for satisfying a voice service and a data service at the same time.

The antenna layout in the present preferred embodiments is further described in detail with reference to the accompanying drawings in the following.

As shown in FIG. 1 and FIG. 2, the numbers in the figures respectively represent: 1. an LTE primary antenna; 2. an LTE secondary antenna; 3. a 3G antenna; 4. an antenna feed point; 5. an antenna ground feed point; 6. metal ground; 7. a through hole; 8. a mainboard PCB; and 9. a mainboard reference ground.

In the preferred embodiment, an example of a wireless access terminal is used for illustration, and the wireless access terminal demands to satisfy data transmission services of LTE band 2 and band 5, and at the same time satisfy voice services of band 2 and band 5. Besides, a data service of an LTE and a voice service of 3G are realized on two different modules. The LTE supports MIMO technology, and thus requires two LTE antennae, and the 3G requires one antennae. Since the three antennae work on the same frequency band, the design of isolation degree among them is a key technology. Being restricted by the size of the mainboard, the isolation degree of the antennae cannot be further improved by pulling away the positions between antennae. As shown in FIG. 1, a secondary antenna 2 of an LTE is provided on the top of a mainboard 8, and a 3G antenna 3 is provided in the left, and an LTE primary antenna 1 is provided in a right area. According to a practical simulation test, frequency band isolation degree, which is between the 3G antenna and the LTE secondary antenna, of band 5 is 9 dB, and frequency band isolation degree, which is between the 3G antenna and the LTE secondary antenna, of band 2 is 12 dB, and frequency band isolation degree, which is between the LTE secondary antenna and the primary antenna, of band 5 is 11 dB, and frequency band isolation degree, which is between the LTE secondary antenna and the primary antenna, of band 2 is 13 dB, and frequency band isolation degree, which is between a 3G primary antenna and the LTE primary antenna, of band 5 is 14 dB, and frequency band isolation degree, which is between a 3G primary antenna and the LTE primary antenna, of band 2 is 17 dB. With regard to an isolation degree between two antennae, it is generally required to be about 15 dB to satisfy requirements. If the 3G antenna and LTE secondary antenna are provided in the way as stated above, it is obvious that the isolation degree between the LTE secondary antenna and the primary antenna does not meet the requirement.

In the present embodiment, a ground isolation solution is employed to improve isolation degree. As shown in FIG. 1, a 3G antenna 3 and an LTE primary antenna and LTE secondary antenna respectively reserve an antenna feed point 4 and two antenna ground feed points 5. The number of the antenna feed point and antenna ground feed point may be reserved according to practical requirements, and at the same time, a certain metal ground 6 is reserved under each antenna ground feed point. The area and shape of the metal ground 6 may be adjusted according to the layout of components on the mainboard, and these metal grounds are relatively independent, and cannot be connected to the metal ground on the surface of the mainboard, and all the metal ground are respectively connected to a mainboard reference ground 9 through at least one through hole 7, and the number of the at least one through hole is determined according to the requirement of the area of the metal ground, and theoretically, the more, the better. At the moment, according to the simulation test, frequency band isolation degree of band 5 between the 3G antenna and the LTE secondary antenna is 14 dB, and frequency band isolation degree of band 2 between the 3G antenna and the LTE secondary antenna is 16 dB, and frequency band isolation degree of band 5 between the LTE secondary antenna and the primary antenna is 17 dB, and frequency band isolation degree of band 2 between the LTE secondary antenna and the primary antenna is 19 dB, and frequency band isolation degree of band 5 between the 3G primary antenna and the LTE primary antenna is 15 dB, and frequency band isolation degree of band 2 between the 3G primary antenna and the LTE primary antenna is 18 dB, thereby basically satisfying the requirements of isolation degree.

With regard to antennae working in different frequency band ranges, a impedance bandwidth of an antenna may be adjusted by reserving antenna matching, a feed position, a ground position and an antenna form on a PCB board, and specifically, optimization may be performed according to results of previous antenna simulation, passive test and active test, thereby eventually reaching an expected target.

It should be noted that the above-mentioned wireless device comprises but is not limited to a mobile phone, and also may be applied in all places where the antenna technology may be applied, such as wireless access.

The above description is only preferred embodiments of the present disclosure and is not intended to limit the present disclosure, and the present disclosure can have a variety of changes and modifications for ordinary person skilled in the field. Any modification, equivalent replacement, or improvement made within the spirit and principle of the present disclosure shall all fall within the protection scope of the present disclosure.

1. A wireless device, comprising a mainboard (8) and a plurality of antennae, wherein
a surface of the mainboard (8) is provided with the plurality of antennae, and an interior of the mainboard (8) comprises a mainboard reference ground (9), and each of the plurality of antennae is electrically connected to the mainboard reference ground (9) respectively.

2. The wireless device according to claim 1, wherein the each of the plurality of antennae comprises at least one antenna ground feed point (5); and the wireless device further comprises: a plurality of metal grounds (6) respectively connected to the at least one antenna ground feed point (5), wherein the each of the plurality of metal grounds (6) is electrically connected to the mainboard reference ground (9).

3. The wireless device according to claim 2, wherein the number of the at least one antenna ground feed point (5) comprised by the each of the plurality of antennae is greater than or equal to 2.

4. The wireless device according to claim 3, wherein the at least one antenna ground feed point (5) is provided in a middle part and/or end part of the each of the plurality of antennae.

5. The wireless device according to claim 2, wherein the each of the plurality of metal grounds (6) comprises at least one through hole (7), and the each of the plurality of metal grounds (6) is electrically connected to the mainboard reference ground (9) via the at least one through hole (7).

6. The wireless device according to claim 5, wherein the number of the at least one through hole (7) comprised by the each of the plurality of metal grounds (6) is determined according to an area of the each of the plurality of metal grounds (6).

7. The wireless device according to claim 1, wherein the plurality of antennae are provided on edges of different sides of the mainboard (8).

8. The wireless device according to claim 1, wherein the plurality of antennae comprise at least two of the following: a long term evolution (LTE) primary antenna (1), an LTE secondary antenna (2), a third generation 3G antenna (3) and a wireless fidelity technology (WiFi) antenna.

9. The wireless device according to claim 1, wherein the each antenna of the plurality of antennae comprises at least one antenna feed point (4).

10. The wireless device according to claim 2, wherein the plurality of antennae are provided on edges of different sides of the mainboard (8).

11. The wireless device according to claim 3, wherein the plurality of antennae are provided on edges of different sides of the mainboard (8).

12. The wireless device according to claim 4, wherein the plurality of antennae are provided on edges of different sides of the mainboard (8).

13. The wireless device according to claim 5, wherein the plurality of antennae are provided on edges of different sides of the mainboard (8).

14. The wireless device according to claim 2, wherein the plurality of antennae comprise at least two of the following: a long term evolution (LTE) primary antenna (1), an LTE secondary antenna (2), a third generation 3G antenna (3) and a wireless fidelity technology (WiFi) antenna.

15. The wireless device according to claim 3, wherein the plurality of antennae comprise at least two of the following: a long term evolution (LTE) primary antenna (1), an LTE secondary antenna (2), a third generation 3G antenna (3) and a wireless fidelity technology (WiFi) antenna.

16. The wireless device according to claim 4, wherein the plurality of antennae comprise at least two of the following: a long term evolution (LTE) primary antenna (1), an LTE secondary antenna (2), a third generation 3G antenna (3) and a wireless fidelity technology (WiFi) antenna.

17. The wireless device according to claim 5, wherein the plurality of antennae comprise at least two of the following: a long term evolution (LTE) primary antenna (1), an LTE secondary antenna (2), a third generation 3G antenna (3) and a wireless fidelity technology (WiFi) antenna.

18. The wireless device according to claim 2, wherein the each antenna of the plurality of antennae comprises at least one antenna feed point (4).

19. The wireless device according to claim 3, wherein the each antenna of the plurality of antennae comprises at least one antenna feed point (4).

20. The wireless device according to claim 4, wherein the each antenna of the plurality of antennae comprises at least one antenna feed point (4).
